(19) United States
(12) Patent Application Publication
(10) Pub. No.: US 2010/0195473 A1
(43) Pub. Date: Aug. 5, 2010

(54) SIGNAL TRANSMISSION CIRCUIT AND STORAGE DEVICE

(75) Inventor: Isao TSUYAMA, Oume-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/760,397

(22) Filed: Apr. 14, 2010

Related U.S. Application Data
(63) Continuation of application No. PCT/JP2007/070081, filed on Oct. 15, 2007.

(51) Int. Cl. G11B 7/00; H04J 14/02; H04B 10/08

(52) U.S. Cl. 369/102; 398/79; 398/38; G9B/7

(57) ABSTRACT

According to one embodiment, a signal transmission circuit includes: a first electro optical converter converting a read electric signal to a first optical signal having an optional wavelength λR; a first photo-electric converter configured to reconvert the first optical signal to the read electric signal; a second electro optical converter converting a electric signal to be recorded to a second optical signal having a wavelength λW different from the λR; a second photo-electric converter reconverting the second optical signal to the electric signal to be recorded; a first optical multiplexer/demultiplexer connected to the first electro optical converter and the second photo-electric converter, and multiplexing and demultiplexing the first and second optical signals; a second optical multiplexer/demultiplexer multiplexing and demultiplexing the first and second optical signals; and an optical transmission medium connected to the first and second optical multiplexers/demultiplexers, and transmits the multiplexed first and second optical signals.

### CROSS-REFERENCE TO RELATED APPLICATIONS

This application is a continuation of PCT international application Ser. No. PCT/JP2007/070081 filed on Oct. 15, 2007 which designates the United States, incorporated herein by reference.

### BACKGROUND

1. Field

One embodiment of the invention relates to a signal transmission circuit and a storage device. More specifically, the present invention relates to a signal transmission circuit suitable for high-speed signal transmission and a storage device that includes such a signal transmission circuit.

2. Description of the Related Art

In a magnetic disk device (hard disk drive (HDD)) that is an example of conventional storage devices, signal transmission between a magnetic head and a signal processing circuit is performed through a mechanical actuator arm. The actuator arm, due to its structure, needs to be physically long to some extent. Accordingly, there is a limit in reducing the physical distance of a signal transmission path on the actuator arm, thereby making it difficult to design the signal transmission path with only a small signal loss or small signal degradation, less likely to be affected by disturbance, and that can realize high-speed data transfer rate.

In the conventional HDD, a flexible printed circuit board (FPC) and the like is used to form the signal transmission path, or an interface between the magnetic head and the signal processing circuit, with electrical lines. If recording density is increased in the future with an adoption of a recording system such as a perpendicular recording system or with an improved characteristics of a recording medium, the data transfer rate is further increased. Accordingly, the interface is required to respond to high-speed data transfer rate. Even at present, data transfer rate of an HDD for mobile personal computers (PCs) has reached 1.5 GHz, and data transfer rate of a high performance HDD for enterprise, for example, exceeds 2 GHz. If the data transfer rate is further increased, impedance mismatch in the signal transmission path, and signal attenuation and degradation due to cross-talk, are more pronounced. Accordingly, it is anticipated that it will be difficult to maintain the quality of signals on the signal transmission path with the technology used in conventional HDDs.

Japanese Patent Application Publication (KOKAI) No. H5-28402 discloses a magnetic disk device that optically transmits signals on a head arm. Japanese Patent Application Publication (KOKAI) No. H6-119601 discloses a magnetic recording-reading device that performs signal transmission between a rotational drum including a magnetic head and a fixed drum, by using an optical fiber. Japanese Patent No. 2661527 discloses a differential amplifier circuit that includes a squaring circuit. Japanese Patent Application Publication (KOKAI) No. S58-94247 discloses a driving method for controlling a light-emitting element with an integrated output of an analog signal from the light-emitting element.

In the conventional technology, it is difficult to design the signal transmission path with only a small signal loss or small signal degradation, less likely to be affected by disturbance, and that can realize high-speed data transfer rate.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a signal transmission circuit according to a first embodiment of the invention;

FIG. 2 is an exemplary block diagram of a signal transmission circuit according to a second embodiment of the invention:

FIG. 3 is an exemplary block diagram of a signal transmission circuit according to a third embodiment of the invention:

FIG. 4 is an exemplary block diagram of a signal transmission circuit according to a fourth embodiment of the invention;

FIG. 5 is an exemplary block diagram of a signal transmission circuit according to a fifth embodiment of the invention;

FIG. 6 is an exemplary block diagram of a signal transmission circuit according to a sixth embodiment of the invention;

FIG. 7 is an exemplary block diagram illustrating connection states of switch circuits during reading in the embodiment;

FIG. 8 is an exemplary block diagram illustrating connection states of switch circuits during writing in the embodiment;

FIG. 9 is an exemplary block diagram of a controller and a light driving circuit composed of an integrated circuit (IC) in the embodiment;

FIG. 10 is an exemplary block diagram of an optical transmitting module in a read system in the embodiment;

FIG. 11 is an exemplary circuit diagram of a light driving circuit in the embodiment;

FIG. 12 is an exemplary graph illustrating the characteristics of the light driving circuit in the embodiment;

FIG. 13 is exemplary graphs illustrating a concept of enlarging a linear region of a differential amplifier in the embodiment;

FIG. 14A is an exemplary circuit diagram of an unbalanced differential pair in the embodiment;

FIG. 14B is an exemplary circuit diagram of another unbalanced differential pair in the embodiment;

FIG. 15 is an exemplary circuit diagram of a gm amplifier in the embodiment;

FIG. 16 is an exemplary graph illustrating simulation results of the gm amplifier in FIG. 15;

FIG. 17 is an exemplary circuit diagram of the light driving circuit that includes the gm amplifier in FIG. 15 in the embodiment;

FIG. 18 is an exemplary block diagram of a transfer function of a primary high-frequency-emphasizing-type equalizer in the embodiment;

FIG. 19 is an exemplary graph illustrating an amplitude characteristic of the primary high-frequency-emphasizing-type equalizer in FIG. 18;

FIG. 20 is an exemplary symbolized circuit diagram of the block diagram in FIG. 18;

FIG. 21 is an exemplary block diagram of a transfer function of a secondary high-frequency-emphasizing-type equalizer in the embodiment;

FIG. 22 is an exemplary symbolized circuit diagram of the block diagram in FIG. 21;

FIG. 23 is an exemplary circuit diagram of a gm amplifier used for a pre-equalizer in the embodiment;

FIG. 24 is another exemplary circuit diagram of a gm amplifier used for the pre-equalizer in the embodiment;

FIG. 25A is an exemplary plan view of an actuator arm of a magnetic disk device in the embodiment;

FIG. 25B is an exemplary enlarged perspective view of a circled portion in FIG. 25A; and

FIG. 25C is an exemplary cross-sectional view of the actuator arm in the embodiment.

### DETAILED DESCRIPTION

Various embodiments according to the invention will be described hereinafter with reference to the accompanying drawings. In general, according to one embodiment of the invention, a signal transmission circuit includes: a first electro optical converter configured to convert a read electric signal to a first optical signal having an optional wavelength λR; a first photo-electric converter configured to reconvert the first optical signal to the read electric signal; a second electro optical converter configured to convert a electric signal to be recorded to a second optical signal having a wavelength λW different from the wavelength λR; a second photo-electric converter configured to reconvert the second optical signal to the electric signal to be recorded; a first optical multiplexer/demultiplexer connected to the first electro optical converter and the second photo-electric converter, and configured to multiplex and demultiplex the first optical signal and the second optical signal; a second optical multiplexer/demultiplexer connected to the second electro optical converter and the first photo-electric converter, and configured to multiplex and demultiplex the first optical signal and the second optical signal; and an optical transmission medium connected to the first optical multiplexer/demultiplexer and the second optical multiplexer/demultiplexer, and configured to transmit the multiplexed first and second optical signals.

According to another embodiment of the invention, a storage device includes: a head module including a reading element and a recording element; and a signal transmission circuit connected to the head module, wherein the signal transmission circuit includes: a first electro optical converter configured to convert a read electric signal from the reading element to a first optical signal having an optional wavelength λR; a first photo-electric converter configured to reconvert the first optical signal to the read electric signal; a second electro optical converter configured to convert a electric signal to be recorded from the recording element to a second optical signal having a wavelength λW different from the wavelength λR; a second photo-electric converter configured to reconvert the second optical signal to the electric signal to be recorded; a first optical multiplexer/demultiplexer connected to the first electro optical converter and the second photo-electric converter, and configured to multiplex and demultiplex the first optical signal and the second optical signal; a second optical multiplexer/demultiplexer connected to the second electro optical converter and the first photo-electric converter, and configured to multiplex and demultiplex the first optical signal and the second optical signal; and an optical transmission medium connected to the first optical multiplexer/demultiplexer and the second optical multiplexer/demultiplexer, and configured to transmit the multiplexed first and second optical signals.

In exemplary embodiments of the present invention, by focusing on advantages of optical signals, a signal transmission circuit includes an optical transmission path, for example, with only a small signal loss or small signal degradation in signal transmission equal to or less than hundreds of meters, less likely to be affected by disturbance, and that can realize high-speed data transfer rate.

By optically transmitting signals, it is possible to overcome various difficulties encountered in designing a transmission path, such as impedance matching, and maintaining and optimizing quality factors like transmission distance and signal speed, and to freely set a transmission rate.

By adopting a structure in which conversion efficiency of light-emitting element and sensitivity of the light-receiving element are controlled by current, signal level can be optimized (amplified) in an optical range. Accordingly, a structure of a portion of a high frequency amplifier circuit can be simplified as a whole.

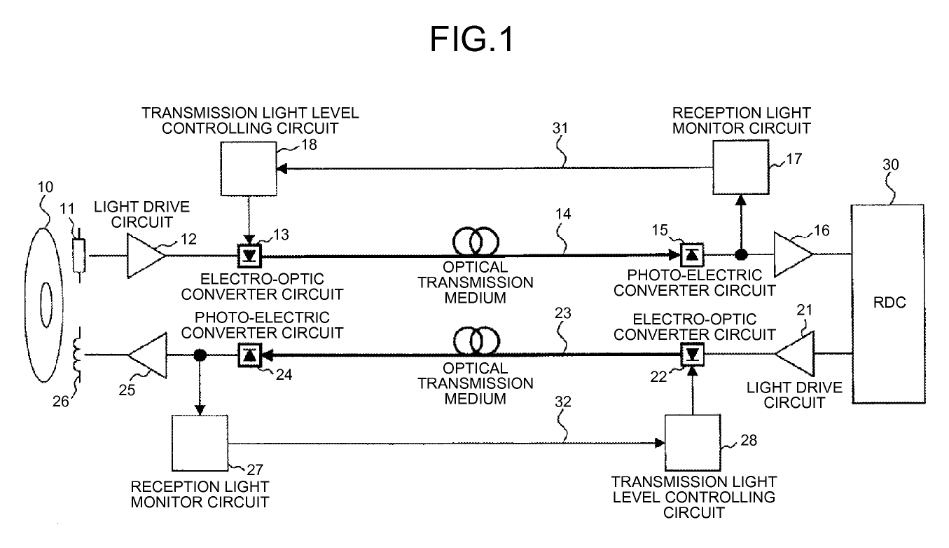

FIG. 1 is an exemplary block diagram of a signal transmission circuit according to a first embodiment of the invention. In the embodiment, signals are optically transmitted, by assigning an optical transmission medium such as an optical fiber or an optical waveguide, to each of a read signal path and a write signal path, independently. In the embodiment and other embodiments described later, for descriptive purposes, the cases will be explained in which the present invention is applied to a magnetic disk device that is an example of storage devices. However, the signal transmission circuit is applicable for various types of storage devices other than the magnetic disk device and various types of devices that use a signal transmission path whose length is equal to or less than hundreds of meters.

As illustrated in FIG. 1, a read system includes a read head 11 that reproduces (reads) a signal from a magnetic disk 10 to output a reproduced electric signal (hereinafter, referred to as read signal), a light driving circuit 12, an electro optical converter circuit 13 that is a first electro optical converter, an optical transmission medium 14 that is a read signal path, a photo-electric converter circuit 15 that is a first photo-electric converter, a read amplifier 16, a reception light monitoring circuit 17, and a transmission light level controlling circuit 18. A write system includes a light driving circuit 21, an electro optical converter circuit 22 that is a second electro optical converter, an optical transmission medium 23 that is a write signal path, a photo-electric converter circuit 24 that is a second photo-electric converter, a write amplifier 25, a write head 26 that records (writes) a electric signal to be recorded (hereinafter, referred to as write signal) on the magnetic disk 10, a reception light monitoring circuit 27, and a transmission light level controlling circuit 28. Each of the read amplifier 16 and the light driving circuit 21 is connected to a read channel (RDC) 30 that performs desired signal processing on the read signal and the write signal.

In a structure illustrated in FIG. 1, a circuit portion other than the magnetic disk 10, the heads 11 and 26, the amplifiers 16 and 25, and the RDC 30 corresponds to the signal transmission circuit. The electro optical converter circuits 13 and 22 may be formed of light-emitting elements such as laser diodes. The photo-electric converter circuits 15 and 24 may be formed of light-receiving elements such as photodiodes.

In the read system, the light driving circuit 12 performs predetermined equalization and amplification on the read signal from the read head 11. The electro optical converter circuit 13 converts the read signal to an optical signal. The optical signal is transmitted to the photo-electric converter circuit 15 through the optical transmission medium 14 to be converted into an electric signal. The electric signal is supplied to the RDC 30 through the read amplifier 16. The electric signal is also supplied to the reception light monitoring circuit 17 where the reception light level is monitored. Information on the signal level detected by the reception light monitoring circuit 17 is fed back to the transmission light level controller 18 through a control line 31. The transmission light level controller 18 controls an output optical power output from the electro optical converter circuit 13, so that a level of the optical signal transmitted through the optical transmission medium 14 is within an allowable range.

In the write system, the light driving circuit 21 performs predetermined equalization and amplification on the write signal from the RDC 30. The electro optical converter circuit 22 converts the write signal to an optical signal. The optical signal is transmitted to the photo-electric converter circuit 24 through the optical transmission medium 23 to be converted into an electric signal. The electric signal is written on the magnetic disk 10 by the write head 26 through the write amplifier 25. The electric signal is also supplied to the reception light monitoring circuit 27 where the reception light level is monitored. Information on the signal level detected by the reception light monitoring circuit 27 is fed back to the transmission light level controller 28 through a control line 32. The transmission light level controller 28 controls an output optical power output from the electro optical converter circuit 22, so that a level of the optical signal transmitted through the optical transmission medium 23 is within an allowable range.

The following two methods may be used in order to keep the level of the optical signal transmitted through the optical transmission medium 14 or 23. The first method is used to suppress variations of an optical output level in a transmitting side. In the first method, for example, the optical output level is kept constant by providing a control target corresponding to the optical output characteristics of the electro optical converter circuit 13, to the transmission light level controlling circuit 18. In this case, the signal level in a receiving side varies to some extent. Alternatively, the second method is used to suppress variation of an optical input level in the receiving side. In the second method, for example, a reception signal level is kept constant by providing a control target value to the reception light monitoring circuit 17. In this case, the transmitting side requires a relatively high optical drive capability.

For a simplification of an optical transmission path and multi-channelization of a signal, the read signal and the write signal may be transmitted through a single optical transmission path. For example, bidirectional optical transmission can be carried out by using an optical circulator, and the transmission of the read signal and the transmission of the write signal can be performed at the same time. The simultaneous and bidirectional optical transmission can also be performed, by using an optical wavelength division multiplexing technology. This is enabled by assigning different wavelengths to light of the read signal and light of the write signal, respectively.

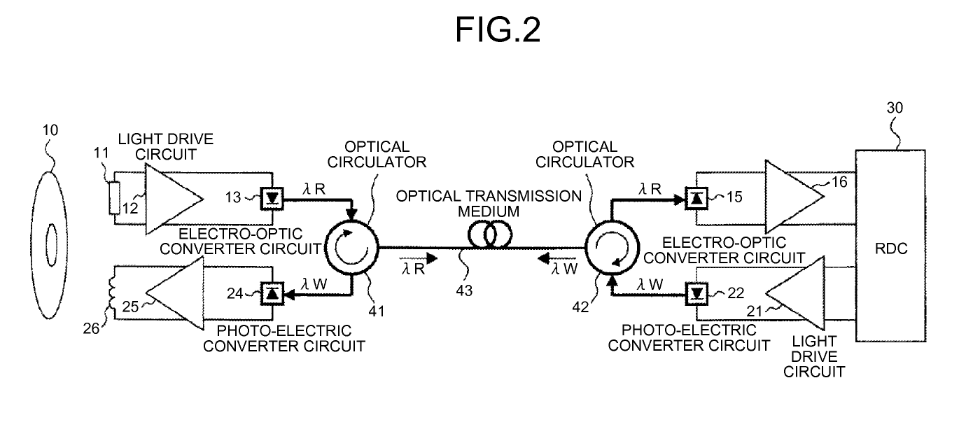

FIG. 2 is an exemplary block diagram of a signal transmission circuit according to a second embodiment of the invention. In FIG. 2, elements that are substantially the same as those in FIG. 1 are designated by the same reference numerals, and the descriptions thereof are omitted. In the embodiment, unlike the structure of FIG. 1, the bidirectional optical transmission is performed by commonly using a single optical transmission medium in both of the read system and the write system.

As illustrated in FIG. 2, the electro optical converter circuit 13 and the photo-electric converter circuit 24 are connected to an optical circulator 41 that is a first optical multiplexer/demultiplexer. The photo-electric converter circuit 15 and the electro optical converter circuit 22 are connected to an optical circulator 42 that is a second optical multiplexer/demultiplexer. The optical circulators 41 and 42 are connected each other with an optical transmission medium 43 such as an optical fiber or an optical waveguide. In this manner, both the read signal path and the write signal path are provided by the single optical transmission medium 43. Accordingly, it is preferable to perform bidirectional transmission, by assigning different wavelengths to a wavelength λR of the read signal and a wavelength λW of the write signal, respectively. However, judging from the nature of the optical circulators 41 and 42, the same wavelength may be used for the wavelength λR of the read signal and the wavelength λW of the write signal if light reflection in the optical transmission medium 43 is not a problem.

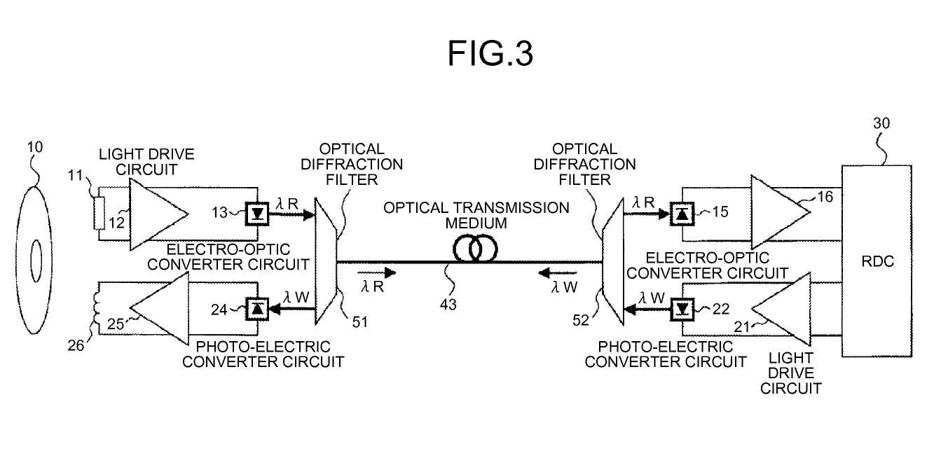

FIG. 3 is an exemplary block diagram of a signal transmission circuit according to a third embodiment of the invention. In FIG. 3, elements that are substantially the same as those in FIG. 2 are designated by the same reference numerals, and the descriptions thereof are omitted. In the embodiment, optical multiplexer/demultiplexer circuits 51 and 52 such as an optical diffraction filter are used instead of the optical circulators 41 and 42 in FIG. 2.

The optical multiplexer-demultiplexer circuit 51 is the first optical multiplexer/demultiplexer, and the optical multiplexer-demultiplexer circuit 52 is the second optical multiplexer/demultiplexer. In this manner, because the optical wavelength division multiplexing technology is used in the embodiment, different wavelengths need to be assigned to the wavelength λR of the read signal and the wavelength λW of the write signal, respectively.

The bidirectional communication may also be performed through a single transmission path by switching between reading and writing, using optical switching technology.

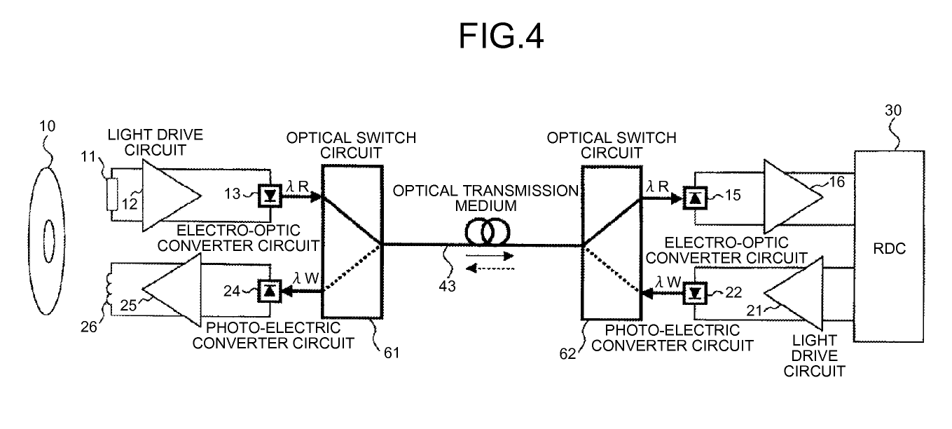

FIG. 4 is an exemplary block diagram of a signal transmission circuit according to a fourth embodiment of the invention. In FIG. 4, elements that are substantially the same as those in FIG. 2 are designated by the same reference numerals, and the descriptions thereof are omitted. In the embodiment, optical switch circuits 61 and 62 are used instead of the optical circulators 41 and 42 in FIG. 2. The optical switch circuit 61 is the first optical multiplexer/demultiplexer, and the optical switch circuit 62 is the second optical multiplexer/demultiplexer.

In the structures in FIGS. 2 and 3, the optical transmission medium 43 is used as the read transmission path and the write transmission path, passively by using the properties of light. Accordingly, the read signal and the write signal can be transmitted at the same time. In contrast, in the embodiment, the optical transmission medium 43 is selectively used as the read transmission path or the write transmission path, by actively switching between the optical switch circuits 61 and 62. Accordingly, the read signal and the write signal cannot be transmitted through the optical transmission medium 43 at the same time.

In a fifth embodiment of the invention, the structure in FIG. 1 is added to any one of the structures in FIGS. 2 to 4. When the structure in FIG. 1 is added to the structure in FIG. 4, the optical switch circuit must be controlled by dividing the time between the reading and the writing, in other words, in a time division manner.

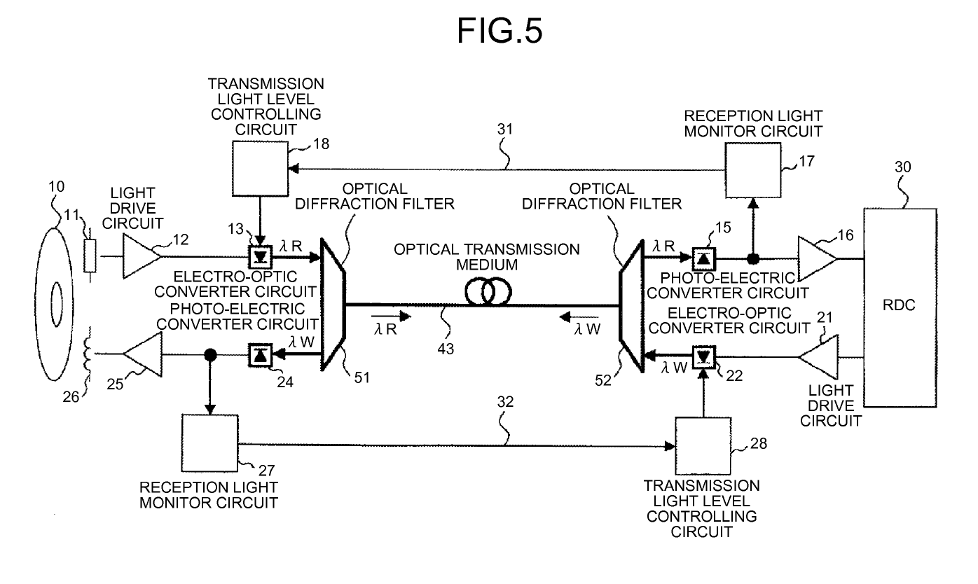

FIG. 5 is an exemplary block diagram of a signal transmission circuit according to a fifth embodiment of the invention. In FIG. 5, elements that are substantially the same as those in FIGS. 1 and 3 are designated by the same reference numerals, and the descriptions thereof are omitted. As illustrated in FIG. 5, as an example, the structure in FIG. 1 is added to the structure in FIG. 3.

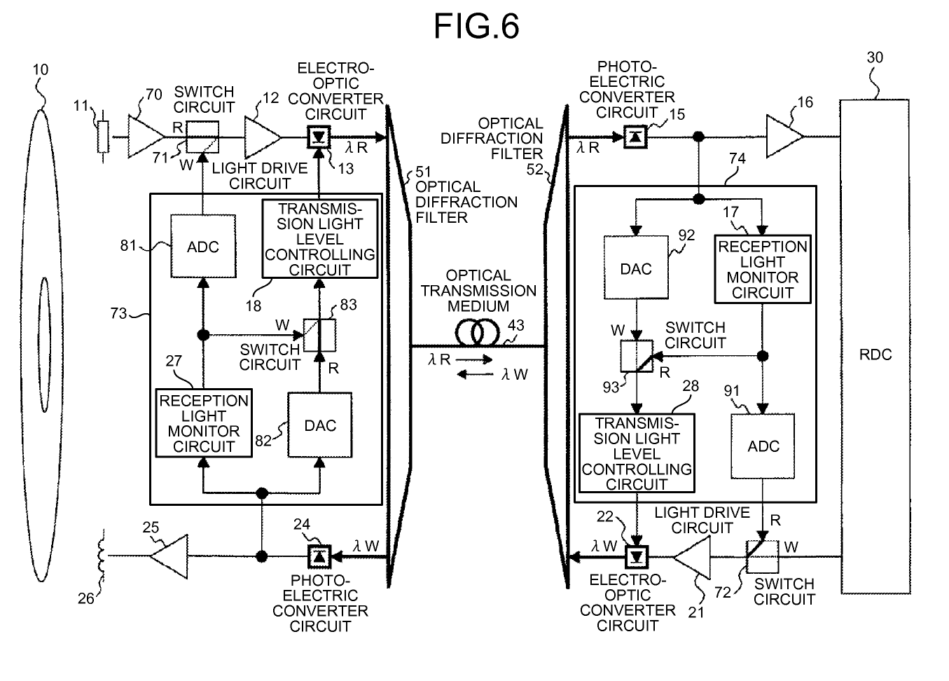

FIG. 6 is an exemplary block diagram of a signal transmission circuit according to a sixth embodiment of the invention. In FIG. 6, elements that are substantially the same as those in FIG. 5 are designated by the same reference numerals, and the descriptions thereof are omitted. In the structure in FIG. 5, the control lines 31 and 32 are required in addition to the optical transmission medium 43. However, in the embodiment, control information is also transmitted through the optical transmission medium 43. Accordingly, the number of control lines is reduced, thereby further simplifying an interface.

As illustrated in FIG. 6, a read pre-amplifier 70 and a switch circuit 71 are provided between the read head 11 and the light driving circuit 12. A switch circuit 72 is provided between the RDC 30 and the light driving circuit 21. A controller 73 includes the transmission light level controlling circuit 18 that is a first output level controller, the reception light monitoring circuit 27 that is a second output level monitor, an analog-to-digital converter (ADC) 81, a digital-to-analog converter (DAC) 82, and a switch circuit 83. A controller 74 includes the transmission light level controlling circuit 28 that is a second output level controller, the reception light monitoring circuit 17 that is a first output level monitor, an analog-to-digital converter (ADC) 91, a digital-to-analog converter (DAC) 92, and a switch circuit 93. As illustrated in FIG. 6, terminals R of the switch circuits 71, 72, 83, and 93 are used for selective output during the reading, and terminals W of the switch circuits 71, 72, 83, and 93 are used for selective output during the writing.

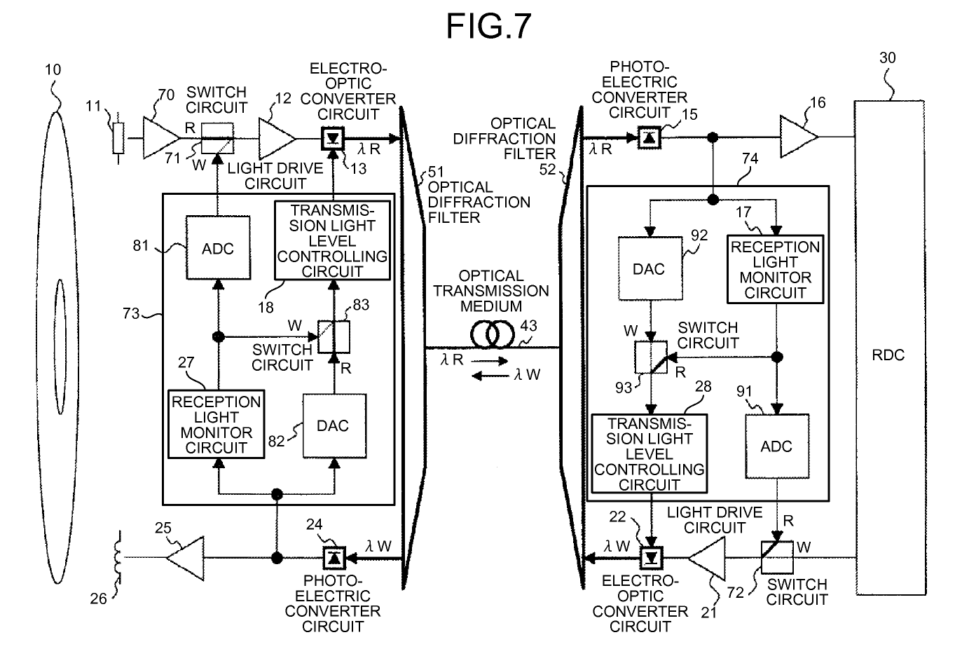

Operations performed during the reading in the embodiment will now be described with reference to FIG. 7. FIG. 7 illustrates connection states of the switch circuits 71, 72, 83, and 93 during the reading. During the reading, switching control is performed so that the switch circuit 71 is connected to the read transmission path, and the switch circuit 72 is connected to the controller 74. The switching control of the switch circuits 71 and 72 is performed by a processor (not shown) such as a central processing unit (CPU) and a micro processing unit (MPU) that controls all of a magnetic disk device. Accordingly, a control loop that feeds back the control information used to control a read transmission power through the write transmission path is formed.

In this time, in the controller 74, switching control is performed so that the switch circuit 93 selectively outputs an output of the reception light monitoring circuit 17. The switching control of the switch circuit 93 is performed by the processor. The reception light monitoring circuit 17 detects analog control information such as information of average power depending on the reception signal level. The ADC 91 digitizes and encodes the analog control information used to control power of the electro optical converter circuit 13 of the read system, detected by the reception light monitoring circuit 17. By digitizing the analog control information to obtain digital control information, it is possible to prevent loss of the control information, resulting from variations of an optical signal processing system. In this case, the transmission light level controlling circuit 28 provides an appropriate bias control signal to the electro optical converter circuit 22.

On the other hand, in the controller 73, switching control is performed so that the switch circuit 83 selectively outputs an output of the DAC 82. The switching control of the switch circuit 83 is performed by the processor. The DAC 82 converts the digital control information transmitted through the write system to analog control information to provide to the transmission light level controlling circuit 18. The transmission light level controlling circuit 18 keeps an output optical power of the electro optical converter circuit 13 at a desired value.

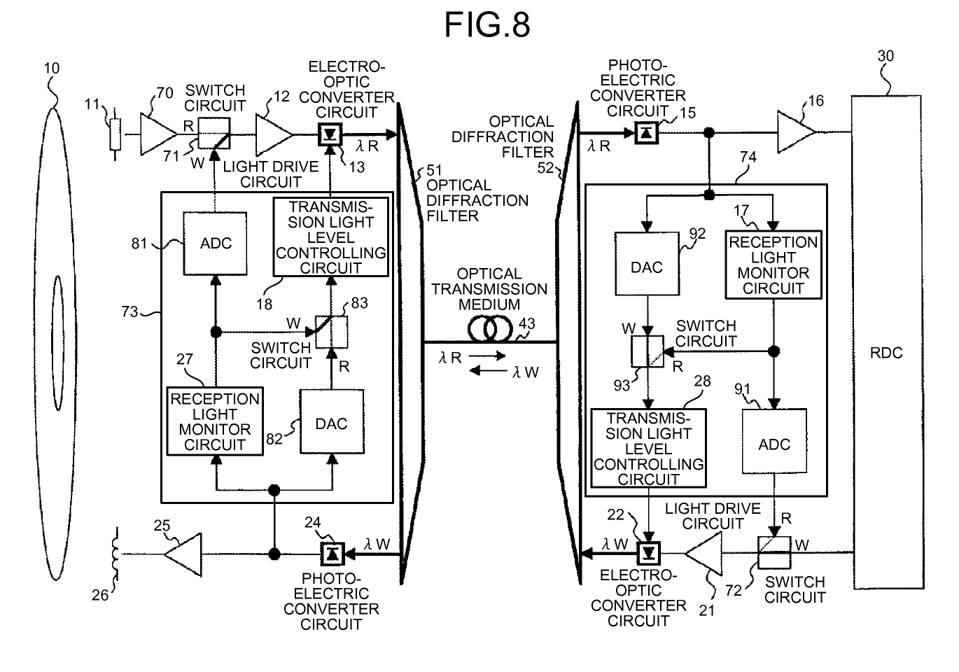

Operations performed during the writing in the embodiment will now be described with reference to FIG. 8. FIG. 8 illustrates connection states of the switch circuits 71, 72, 83, and 93 during the writing. During the writing, switching control is performed so that the switch circuit 71 is connected to the controller 73, and the switch circuit 72 is connected to the write transmission path. Accordingly, a control loop that feeds back control information used to control write transmission power through the read transmission path is formed.

In this manner, during the writing, similar to the operations performed during the reading, the control information digitally encoded by the ADC 81 in the controller 73 is returned to the controller 74 through the read system, and converted into analog control information by the DAC 91 to be provided to the transmission light level controlling circuit 28. The transmission light level controlling circuit 28 keeps output optical power of the electro optical converter 22 at a desired value.

FIG. 6 illustrates a structure in which a wavelength division multiplexing technology is adopted using the optical multiplexer-demultiplexer circuits 51 and 52 as the first and the second optical multiplexer/demultiplexers. Instead of the optical multiplexer-demultiplexer circuits 51 and 52, the optical circulators 41 and 42 illustrated in FIG. 2 may be used as the first and the second optical multiplexer/demultiplexers. However, in this case, because the control information is converted into the optical signal, and a feedback control in which the write transmission path is used during the reading and the read transmission path is used during the writing is carried out, the reading and writing cannot be controlled simultaneously.

According to the second, the third, the fifth, and the sixth embodiments, the recording and the reading can be simultaneously carried out in the storage device, and a problem of impedance mismatch due to an increased transfer rate can be solved by using the optical signal. By multiplexing the read signal and the write signal, the signals can also be transmitted through the single optical transmission medium. Consequently, the signal transmission circuit can be easily mounted on the storage device and the like, and, a problem of cross-talk that occurs in the conventional signal transmission circuit can also be eliminated.

According to the first, the fifth, and the sixth embodiments, changes in the optical signal due to changes in an environment temperature can be feedback controlled. Accordingly, it is possible to output the stable optical signal.

In other words, the conversion efficiency of the light-emitting element and the sensitivity of the light-receiving element vary with a temperature environment, and the like. Accordingly, the optical signal level also changes depending on the temperature environment, and the like, thereby influencing the capability of the light driving circuit and a dynamic range of a reception circuit. In order to optically transmit signals, the control to keep the optical signal level within an allowable range needs to be performed against the environmental variation, and variations and fluctuations in transmission and reception efficiencies. In order to do so, for example, in a field of long-distance optical communication, an optical transmitter integrally formed with not only a light-emitting element but also with a light-receiving element for monitoring transmission power is mainly used. A power of the light-emitting element is controlled based on monitor information from the light-receiving element. However, in this method, a structure of the optical transmitter is complicated and expensive, and therefore, it is not preferable to be used as an interface for a relatively short distance such as in the magnetic disk device.

Accordingly, in the first, the fifth, and the sixth embodiments, the light-receiving element is not only used as a signal transmitting module, but also used as a signal level monitor, and the optical power of the light-emitting element is controlled based on the monitor information of the signal level monitor. More specifically, the reception light monitoring circuit is arranged at the subsequent stage of the light-receiving element. Level information detected by the reception light monitoring circuit is fed back to the transmission light level controlling circuit of the light-emitting element. An automatic light level control system is formed in which the light-emitting element in the transmitting side and the light-receiving element in the receiving side are included in both the read system and the write system.

Further, according to the sixth embodiment, because the feedback control can be carried out through the optical transmission medium, it is advantageous not to require an additional new component. According to the sixth embodiment, it is possible to prevent a loss or a deterioration of signal to noise ratio (SNR) of an output level information of the read signal or the write signal, caused by the variations in the output of the optical signal.

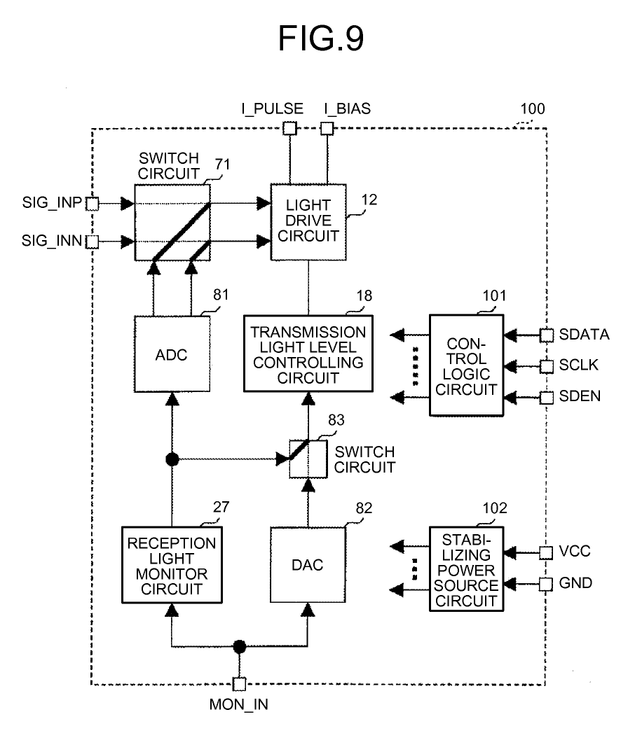

FIG. 9 is an exemplary block diagram of a controller and a light driving circuit composed of an integrated circuit (IC) in the embodiment. For descriptive purposes, the integrated circuit includes the controller 73. Explanation about a structure of an integrated circuit including the controller 74 is omitted because it is similar to that of the integrated circuit including the controller 73.

As illustrated in FIG. 9, an integrated circuit 100 includes the controller 73, the switch circuit 71, the light driving circuit 12, a control logic circuit 101, and a stabilized power supply circuit 102. The controller 73 includes the transmission light level controlling circuit 18, the reception light monitoring circuit 27, the ADC 81, the DAC 82, and the switch circuit 83. SIG_INP and SIG INN denote the read signals output from the read pre-amplifier 70 to be input to integrated circuit 100. MON_IN denotes a signal or information output from the photo-electric converter circuit 24 to be input to the integrated circuit 100. I_PULSE denotes the read signal output from the light driving circuit 12 in the integrated circuit 100 to be supplied to the electro optical converter circuit 13. I_BIAS denotes a bias control signal output from the transmission light level controlling circuit 18 in the integrated circuit 100 to be supplied to the electro optical converter circuit 13 through the light driving circuit 12.

In FIG. 9, VCC denotes a power supply voltage supplied to the stabilized power supply circuit 102 for stabilizing the power supply voltage. GND denotes a ground voltage. The power supply voltage supplied from the stabilized power supply circuit 102 is supplied to modules in the integrated circuit 100. Each of SDATA, SCLK, and SDEN denotes a signal supplied from the processor and the like. SDATA denotes data indicating control contents, SCLK denotes a system clock signal, and SDEN denotes an enable signal. The control logic circuit 101 controls states of the modules in the integrated circuit 100 including connection states of the switch circuits 71 and 83, based on the signals SDATA, SCLK, and SDEN.

By using the mentioned above integrated circuit 100, it is possible to simplify the structure of the optical transmission circuit and reduce a size thereof.

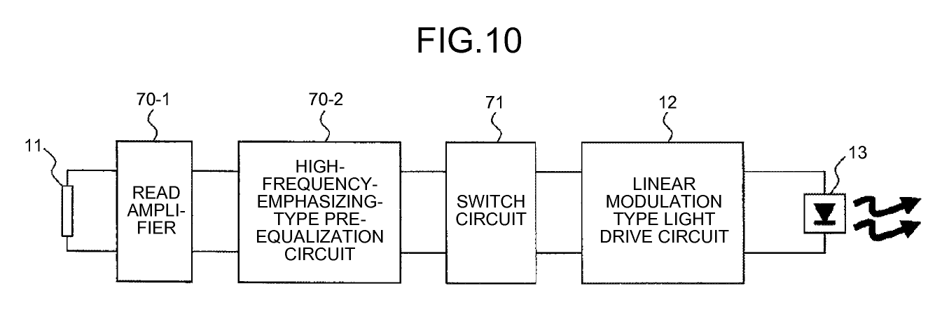

FIG. 10 is an exemplary block diagram of an optical transmitting module in the read system in the embodiment. In FIG. 10, a read amplifier 70-1 and a pre-equalizer performing high-frequency emphasis 70-2 correspond to the pre-amplifier 70 illustrated in FIG. 6. The light driving circuit 12 is a linear modulation type light driving circuit.

In general, the read signal from a magnetic head is an analog signal having a relatively low signal level from millivolts to tens of millivolts. Accordingly, it is particularly important to optically transmit the signals, as the embodiments described above. In general, depending on the conversion efficiency of the light-emitting element, the sensitivity of the light-receiving element, and the loss in the optical transmission path, a drive current from milliamperes to tens of milliamperes is required to drive the light-emitting element. Therefore, the light driving circuit in the read system needs to have a good linearity, have a high transconductance (Gm), and operate at high speed. Therefore, in the embodiments described above, the light driving circuits suitable for such an analog optical transmission are used.

Specifically, data read from the magnetic disk 10 by the read head 11 is an analog signal. Accordingly, in order to convert the analog signal to the optical signal, the light-emitting elements composed of the electro optical converter circuit 13 needs to be linearly driven. Therefore, in the light driving circuit 12, an analog light intensity modulation method is used, instead of turning light on/off by a pulse modulation method generally used in optical communication. The pre-equalizer 70-2 compensates the deterioration of the frequency characteristics of the light driving circuit 12, for example, by providing high-frequency-emphasizing-type characteristics to the deterioration in the high frequency region.

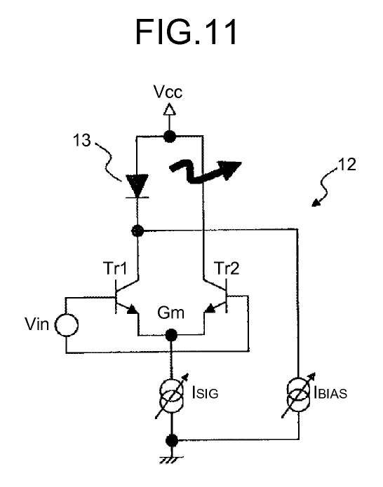

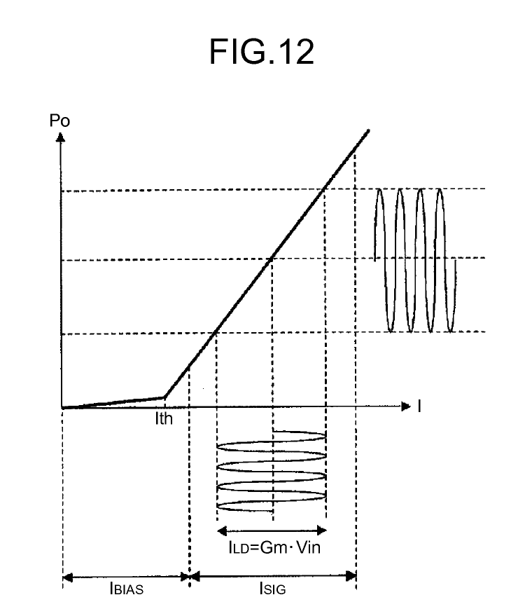

FIG. 11 is an exemplary circuit diagram of the light driving circuit 12 in the embodiment. FIG. 12 is an exemplary graph illustrating the characteristics of the light driving circuit 12 in the embodiment. Because a structure of the light driving circuit 21 is the same as that of the light driving circuit 12, an illustration and description of the structure of the light driving circuit 21 will be omitted.

As illustrated in FIG. 11, the light driving circuit 12 includes a voltage source Vin that supplies a voltage Vin, current sources I_{SIG} and I_{BIAS} that supply currents I_{SIG} and I_{BIAS}, respectively, and transistors Tr1 and Tr2, connected as in the diagram. Gm denotes the transconductance of the transistors Tr1 and Tr2. Vcc denotes the power supply voltage.

As illustrated in FIG. 12, a vertical axis represents output power of the light-emitting element that is composed of the electro optical converter circuit 13 expressed in an arbitrary unit, and a horizontal axis represents a current input to the light-emitting element expressed in an arbitrary unit. Ith denotes a threshold current of the light-emitting element, and I_{LD} denotes a current expressed by I_{LD}=Gm·Vᵢₙ.

The light-emitting element such as a laser diode has the threshold of current (in other words, the threshold current Ith). Accordingly, in order to perform an analog modulation, the bias current I_{BIAS} that exceeds the threshold current Ith of the light-emitting current is supplied, and an intensity modulation proportional to a signal is carried out, in a region where the light-emitting element can sufficiently perform a linear operation.

Following conditions are required for the light driving circuit 12 to be linearly driven: (1) Have a good linearity (in other words, sufficiently cover a range of the read signal from the read head 11, and produce the optical signal with less distortion), (2) Have a large transconductance (Gm) value (in other words, a sufficient laser drive current can be obtained based on a minute input voltage from the read head 11), (3) Have a wide adjustable range of the value Gm (in other words, adaptable to variations in the static characteristics of the light-emitting element due to aging degradation as environmental variations), and the like. Other important conditions required for the light driving circuit 12 are to have a small input offset voltage, and have large output impedance to sufficiently function as a high-speed on-off current source, and the like.

The easiest method to increase a linear region (in other words, a linear operation region of a voltage-current converter circuit) of the differential amplifier including the transistors Tr1 and Tr2 illustrated in FIG. 11, is to insert resistance. However, if the resistance having a fixed resistance value is used, the value gm is determined to be almost the fixed resistance value. Accordingly, the method is not preferable for the light driving circuit 12 because a variability of the value Gm is required. Because a level of the read signal read from the magnetic disk 10 is, for example, approximately tens of millivolts pp, in order to satisfy a sufficient linearity in the range, it is preferable to use the light driving circuit 12 having a good linearity as will be described below.

The value Gm with respect to the current in the differential pair of transistors Tr1 and Tr2 having emitters or sources coupled together has a static characteristic of a single peak. If two single peaks with different peak points are overlapped, it is easily understood that the overlapped lower slope portions are added to form a mountain with a gentle slope. Depending on conditions, a mountain with a substantially flat peak may also be formed. In general, it is known that an input offset is produced if transistors of a balanced differential pair are asymmetric due to relative fluctuation and the like. Accordingly, the linear region of the differential amplifier can be increased by coupling two differential pairs to which the input offsets having different directions from each other are intentionally applied (unbalanced differential pairs).

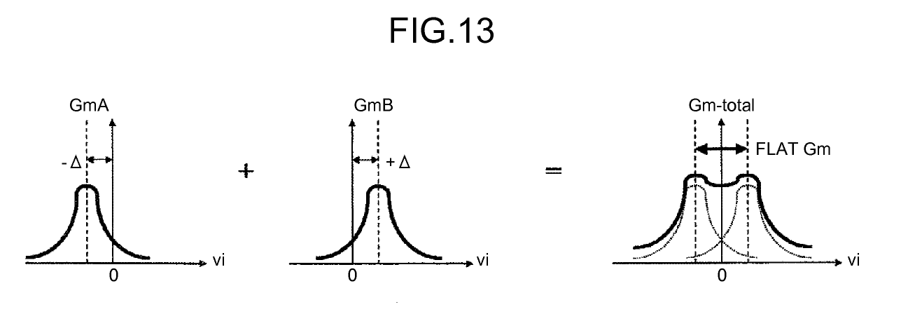

FIG. 13 is exemplary graphs illustrating a concept of enlarging a linear region of a differential amplifier (in other words, a linear operation region of the voltage-current converter circuit), by coupling two unbalanced differential pairs. In FIG. 13, a vertical axis represents a value Gm expressed in an arbitrary unit, and a horizontal axis represents a voltage vᵢ supplied to transistors included in unbalanced differential pairs, expressed in an arbitrary unit. Gₘₚ, and G_{mB} denote respective single-peak characteristics of the two unbalanced differential pairs. The sizes of the values G_{mA} and G_{mB} are the same as each other, but are shifted in opposite directions from each other. Accordingly, it can be estimated that total characteristic (combined characteristics) Gm-total obtained by combining the characteristics of the values G_{mA} and G_{mB} is linear-symmetric under certain conditions, and a value Gm near a center of the total characteristic Gm-total is flattened.

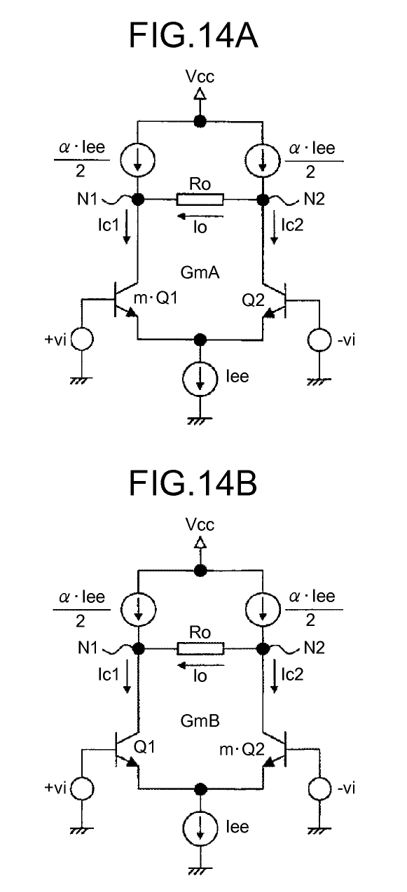

FIGS. 14A and 14B are respective exemplary circuit diagrams of two unbalanced differential pairs in the embodiment. The unbalanced differential pairs are formed by bipolar transistors and in which directions of input offsets are different from each other. As illustrated in FIG. 14A, an unbalanced differential pair A has characteristic G_{mA}, and an emitter size of a transistor Q1 is m times that of a transistor Q2 at a right side. Alternatively, in FIG. 14B, an unbalanced differential pair B has characteristic G_{mB}, and an emitter size of the transistor Q2 is m times that of a transistor Q1. The two differential pairs have respective input offset voltages in directions opposite from each other. In other words, in the two unbalanced differential pairs independent from each other, FIG. 14A illustrates a differential pair of m:1, and FIG. 14B illustrates a differential pair of 1:m.

In FIGS. 14A and 14B, α·Iee/2 denotes an output current of a current source α·Iee/2, and +vᵢ and −vᵢ denote respective output voltages of voltage sources +vᵢ and −vᵢ. Iee denotes an output current of a current source lee. Io denotes a current that flows through a resistance Ro that connects nodes N2 and N1. I_{c1} denotes a current that flows to the transistor Q1 from the Node N1, and I_{c2} denotes a current that flows to the transistor Q2 from the node N2. Vcc denotes a power supply voltage.

A transconductance G_{mA} of the unbalanced differential pair A illustrated in FIG. 14A will now be calculated. Because the emitter size of the transistor Q1 is m times that of the transistor Q2, a base-to-emitter voltage V_{BE1} of the transistor Q1 and a base-to-emitter voltage V_{BE2} of the transistor Q2 are expressed by the following expressions. V_{T} is a thermal voltage expressed by V_{T}=k·T/q, k is a Boltzmann constant (k=1.380×10E-23 [J/K]), T is an absolute temperature [K], and q is the elementary charge of electrons (q=1.602×10E-19 [C]). Is is a reverse direction saturation current of the transistors Q1 and Q2, and for descriptive purposes, it is assumed that a large-scale-integration (LSI) is used, and values Is of the transistors Q1 and Q2 are considered to have the same as each other.

$${V}_{BE 1} = {V}_{T} \cdot ln ( \frac{{I}_{C 1}}{m \cdot Is} )$$

$${V}_{BE 2} = {V}_{T} \cdot ln ( \frac{{I}_{C 2}}{Is} )$$

The emitters of the transistors Q1 and Q2 are directly connected to each other. Accordingly, the input potential difference between the emitters is a voltage difference between V_{BE1} and V_{BE2}. In other words, the following relation is satisfied:

$$2 \cdot {v}_{i} = {V}_{BE 1} - {V}_{BE 2} = {V}_{T} \cdot [ ln ( \frac{{I}_{C 1}}{m \cdot Is} ) - ln ( \frac{{I}_{C 2}}{Is} ) ] = {V}_{T} \cdot ln ( \frac{{I}_{C 1}}{m \cdot {I}_{C 2}} )$$

Accordingly, the following relation is obtained:

$$\frac{{I}_{C 1}}{m \cdot {I}_{C 2}} = exp ( \frac{2 \cdot {v}_{i}}{{V}_{T}} )$$

When the grounded base current amplification factor of the transistors Q1 and Q2 is α, a relation between the collector currents I_{c1} and I_{c2}, and the emitter current I_{EE} is expressed as follows:

I_{C1}+I_{C2}=α·I_{EE}

From the relational expression above, the collector currents I_{c1} and I_{c2} can be obtained by the following expressions:

$${I}_{C 1} = \frac{α \cdot {I}_{EE}}{1 + \frac{1}{m} \cdot exp ( - \frac{2 \cdot {v}_{i}}{{V}_{T}} )} = Icc + {i}_{0}$$

$${I}_{C 2} = \frac{α \cdot {I}_{EE}}{1 + m \cdot exp ( \frac{2 \cdot {v}_{i}}{{V}_{T}} )} = Icc - {i}_{0}$$

In this manner, a differential output signal current i_{0A} of the unbalanced differential pair A is obtained as follows:

$${i}_{0 A} = \frac{{I}_{C 1} - {I}_{C 2}}{2} = \frac{α \cdot {I}_{EE}}{2} \cdot [ \frac{1}{1 + \frac{1}{m} \cdot exp ( - \frac{2 \cdot {v}_{i}}{{V}_{T}} )} - \frac{1}{1 + m \cdot exp ( \frac{2 \cdot {v}_{i}}{{V}_{T}} )} ]$$

Similarly, the unbalanced differential pair B will now be analyzed. In the unbalanced differential pair B, contrary to the unbalanced differential pair A, the emitter size of the transistor Q2 is m times that of the transistor Q1. Accordingly, a differential output signal current i_{0B} is obtained as follows:

$${i}_{0 B} = \frac{{I}_{C 1} - {I}_{C 2}}{2} = \frac{α \cdot {I}_{EE}}{2} \cdot [ \frac{1}{1 + m \cdot exp ( - \frac{2 \cdot {v}_{i}}{{V}_{T}} )} - \frac{1}{1 + \frac{1}{m} \cdot exp ( \frac{2 \cdot {v}_{i}}{{V}_{T}} )} ]$$

The transconductance g_{mA} of the unbalanced differential pair A is obtained as follows, by differentiating the output signal current i_{0A} with respect to the input signal voltage vᵢ:

$$\begin{matrix}{g}_{m A} = \frac{d {i}_{0 A}}{d {v}_{i}} \\ = \frac{α \cdot {I}_{EE}}{{V}_{T}} \cdot \{ \frac{\frac{1}{m} \cdot exp ( - \frac{2 \cdot {v}_{i}}{{V}_{T}} )}{{[ 1 + \frac{1}{m} \cdot exp ( - \frac{2 \cdot {v}_{i}}{{V}_{T}} ) ]}^{2}} + \frac{m \cdot exp ( \frac{2 \cdot {v}_{i}}{{V}_{T}} )}{{[ 1 + m \cdot exp ( \frac{2 \cdot {v}_{i}}{{V}_{T}} ) ]}^{2}} \}\end{matrix}$$

Similarly, the transconductance g_{mB} of the unbalanced differential pair B is obtained as follows, by differentiating the output signal current i_{ce} with respect to the input signal voltage vᵢ:

$$\begin{matrix}{g}_{mB} = \frac{d {i}_{0 B}}{d {v}_{i}} \\ = \frac{α \cdot {I}_{EE}}{{V}_{T}} \cdot \{ \frac{\frac{1}{m} \cdot exp ( \frac{2 \cdot {v}_{i}}{{V}_{T}} )}{{[ 1 + \frac{1}{m} \cdot exp ( \frac{2 \cdot {v}_{i}}{{V}_{T}} ) ]}^{2}} + \frac{m \cdot exp ( - \frac{2 \cdot {v}_{i}}{{V}_{T}} )}{{[ 1 + m \cdot exp ( - \frac{2 \cdot {v}_{i}}{{V}_{T}} ) ]}^{2}} \}\end{matrix}$$

Using the results above, a combined conductance gm of the transconductances gₘₚ, and g_{mB} can finally be calculated as follows:

$$\begin{matrix}{g}_{m} = {g}_{mA} + {g}_{mB} \\ = \frac{α \cdot {I}_{EE}}{m \cdot {V}_{T}} \cdot \{ \begin{matrix}\frac{exp ( - \frac{2 \cdot {v}_{i}}{{V}_{T}} )}{{[ 1 + \frac{1}{m} \cdot exp ( - \frac{2 \cdot {v}_{i}}{{V}_{T}} ) ]}^{2}} + \\ \frac{exp ( \frac{2 \cdot {v}_{i}}{{V}_{T}} )}{{[ 1 + \frac{1}{m} \cdot exp ( \frac{2 \cdot {v}_{i}}{{V}_{T}} ) ]}^{2}}\end{matrix} \} + \frac{m \cdot α \cdot {I}_{EE}}{{V}_{T}} \cdot \\ \{ \begin{matrix}\frac{exp ( \frac{2 \cdot {v}_{i}}{{V}_{T}} )}{{[ 1 + m \cdot exp ( \frac{2 \cdot {v}_{i}}{{V}_{T}} ) ]}^{2}} + \\ \frac{exp ( - \frac{2 \cdot {v}_{i}}{{V}_{T}} )}{{[ 1 + m \cdot exp ( - \frac{2 \cdot {v}_{i}}{{V}_{T}} ) ]}^{2}}\end{matrix} \}\end{matrix}$$

The first term and the second term in the expression above are equal. For example, if each of denominators and numerators in { } of the first term is multiplied by m², it is understood that the first term is equal to the second term. Accordingly, the combined conductance gm is summed up as follows:

$$gm = 2 \cdot \frac{m \cdot α \cdot {I}_{EE}}{{V}_{T}} \cdot \{ \frac{exp ( \frac{2 \cdot {v}_{i}}{{V}_{T}} )}{{[ 1 + m \cdot exp ( \frac{2 \cdot {v}_{i}}{{V}_{T}} ) ]}^{2}} + \frac{exp ( - \frac{2 \cdot {v}_{i}}{{V}_{T}} )}{{[ 1 + m \cdot exp ( - \frac{2 \cdot {v}_{i}}{{V}_{T}} ) ]}^{2}} \}$$

For example, if gm0 is a transconductance obtained when the input voltage vᵢ=0 is applied to the transistors Q1 and Q2, the transconductance gm0 is a function of an emitter size ratio m as the following equation. The value gm near the center is reduced, with the increase of m.

$${g}_{m 0} = \frac{α \cdot {I}_{EE}}{{V}_{T}} \cdot \frac{4 \cdot m}{{( m + 1 )}^{2}}$$

From a different angle, the linearity of the circuit obtained by combining the unbalanced differential pairs A and B is improved, by sacrificing the value gm normally obtained in the balanced state, to some extent.

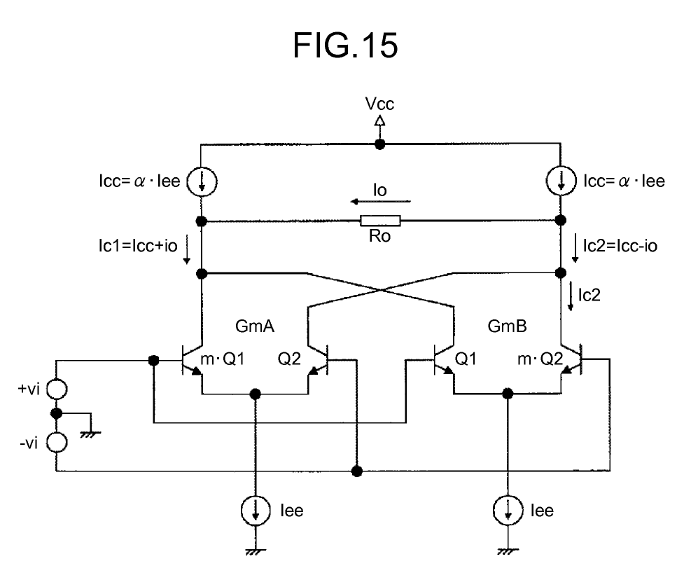

FIG. 15 is an exemplary circuit diagram of a gm amplifier in the embodiment. In the gm amplifier, the linear region is enlarged by coupling the two unbalanced differential pairs A and B. In FIG. 15, elements that are substantially the same as those in FIGS. 14A and 14B are designated by the same reference numerals, and the descriptions thereof are omitted. In FIG. 15, Ic denotes an output current of a current source Ic.

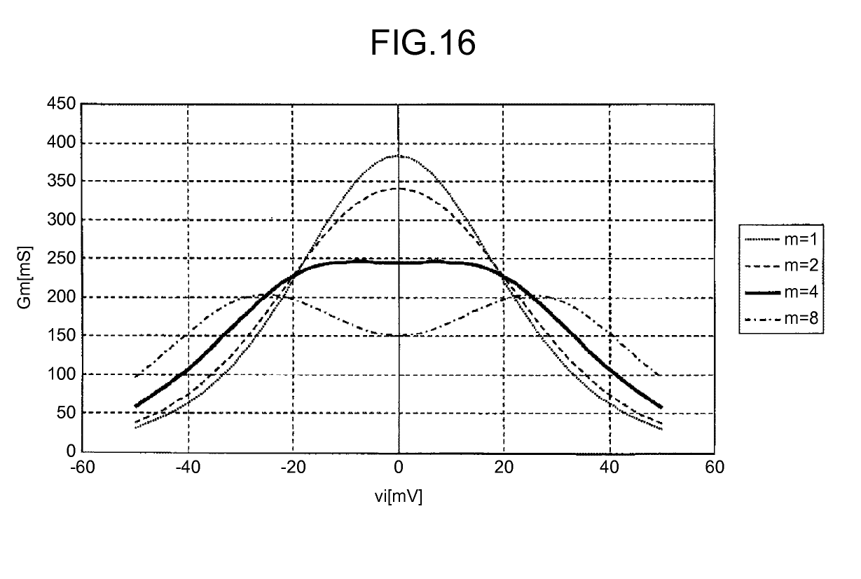

FIG. 16 is an exemplary graph illustrating simulation results of the gm amplifier in FIG. 15. The simulation results are obtained by calculating values gm with respect to the input voltage vᵢ of the gm amplifier in FIG. 15, when m=1, 2, 4, and 8. In FIG. 16, a vertical axis represents a value gm [mS] and a horizontal axis represents an input voltage vᵢ [mV].

As an example, the simulation results in FIG. 16 are obtained when the output current Iee of the current source Iee is 10 milliamperes, and when the grounded base current amplification factor α is 0.99. The differential pairs are balanced when m=1. In this case, the value gm during balance input is reduced with the increase of m, but the gm characteristic flattens out gradually. When m=4, the gm characteristic is substantially flat, and it is observed that the linearity can be obtained within an input range of approximately 12 mVop (=24 mVpp=48 mVpp-diff). When m is further increased, it is observed that the gm characteristic has peaks at symmetric positions and is being overcompensated.

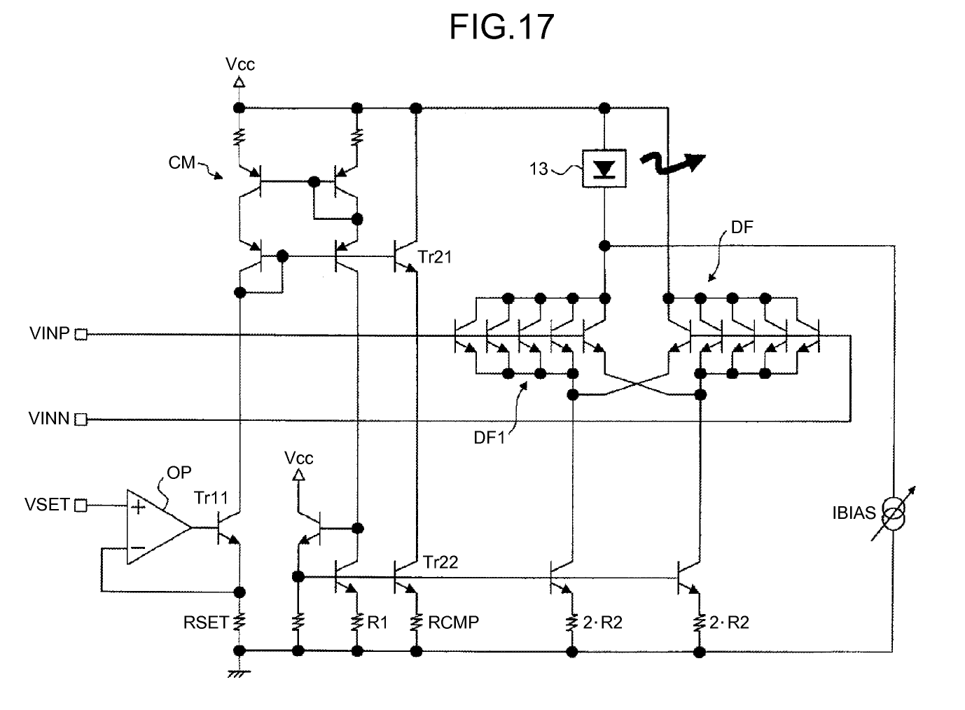

FIG. 17 is an exemplary circuit diagram of the light driving circuit 12 that includes the gm amplifier in FIG. 15, or the voltage-current converter circuit. In FIG. 17, the unbalanced differential pairs having the emitter size ratio of m=4 are coupled. To simplify the circuit diagram, only a signal current portion thereof is illustrated, and an illustration of a bias current portion thereof is omitted. The light driving circuit 12 includes a current mirror circuit CM, an operational amplifier OP, an unbalanced differential pair DM, a current source I_{BIAS}, resistances R_{SET}, R₁, R_{CMP}, 2·R₂, and the like. Vcc is a power supply voltage, and V_{INP}, V_{INN} are respective input voltages to the light driving circuit 12.

In the light driving circuit 12 illustrated in FIG. 17, 21 pieces of bipolar transistors are connected. The bipolar transistors are used, because the value gm of the bipolar transistor is larger than that of a complementary metal-oxide semiconductor (CMOS) transistor. In a voltage amplifier and the like, what basically matters is a ratio of values gm, and a size of the value gm is not so important, except when a high frequency signal is used. A CMOS transistor with a small value gm can be adequately used in a circuit such as an analog filter (Gm-C) circuit, because the size of the value gm can be corrected by a capacity value C. By using the CMOS transistor, it is possible to advantageously use an analog switch and a variable resistance (triode region), and design a flexible circuit. However, if an absolute value of an output current needs be relatively high, such as to drive the light-emitting element, it is preferable that the value gm is as large as possible. From this aspect, the bipolar transistor is more preferable than the CMOS transistor. In the magnetic disk device, the read signal magnetically read from the magnetic disk 10 has a minute voltage. Accordingly, in order to obtain a relatively large current to drive the light-emitting element from the read signal, it is preferable to use the bipolar transistor.

In the light driving circuit 12 in FIG. 17, a control voltage V_{SET} is converted to current by a reference resistance R_{SET}, and the current becomes a signal current source for the analog modulation. In a path through which the drive current of the electro optical converter circuit (light-emitting element) 13 from the reference resistance R_{SET} is output, current passes through two grounded base stages of a voltage-follower circuit formed of the operational amplifier OP and a transistor Tr11, and the unbalanced differential pair DF. The two grounded stages are composed of the transistor Tr11 and a transistor group DF1 of the unbalanced differential pair DF located at the left side. Even if the current mirror circuit CM operates ideally, an error occurs in the output drive current due to variations in the grounded base current amplification factor α at the two grounded base stages. For example, the error may not be a problem if a reception signal is monitored to perform a feedback control. However, the error becomes a problem if a programmable control (feed-forward control) is employed. Accordingly, a module (compensation circuit) for compensating the current error due to the variation in the amplification factor α (may be replaced with a grounded emitter current amplification factor β) is required. In FIG. 17, a current stage that includes transistors Tr21 and Tr22 and a compensation resistance R_{CMP} corresponds to the compensation circuit. A method of compensating the variations in the amplification factor α (β) performed by the compensation circuit will now be described.

First, a case without a compensation circuit (current stage having the compensation resistance R_{CMP}) will now be considered. If the compensation circuit is not present, an output drive current I_{OUT} is expressed by the following expression, and an error factor is the square of the amplification factor α.

$${I}_{OUT} = {α}^{2} \cdot \frac{{R}_{1}}{{R}_{2}} \cdot \frac{{V}_{SET}}{{R}_{SET}} = \frac{{V}_{SET}}{{R}_{SET}} \cdot \frac{{R}_{1}}{{R}_{2}} \cdot {( \frac{β}{1 + β} )}^{2}$$

Next, a case with a compensation circuit will now be considered. To be brief, this compensation circuit functions so as to cancel the attenuation of the collector current at the grounded base stage in the original circuit without the compensation circuit, with a base current of the compensation resistance R_{CMP} stage. Collector current of a PNP output stage (resistance R₁ stage) is expressed by the following expression. A relation between current in the resistance R₁ stage and current in the compensation resistance R_{CMP} stage is simply given by a resistance ratio, by assuming that the current mirror circuit CM is ideal.

$${I}_{1} = α \cdot \frac{{V}_{SET}}{{R}_{SET}} + ( 1 - α ) \cdot {I}_{CMP} = α \cdot \frac{{V}_{SET}}{{R}_{SET}} + ( 1 - α ) \underbrace{\frac{{R}_{1}}{{R}_{CMP}} \cdot {I}_{1}}_{= {I}_{CMP}}$$

In this manner, the current in the resistance R₁ stage is summed up as follows:

$${I}_{1} = \frac{α \cdot \frac{{V}_{SET}}{{R}_{SET}}}{1 - ( 1 - α ) \cdot \frac{{R}_{1}}{{R}_{CMP}}}$$

Accordingly, the output drive current I_{OUT} is expressed as follows:

$${I}_{OUT} = α \cdot \frac{{R}_{1}}{{R}_{2}} \cdot {I}_{1} = {α}^{2} \cdot \frac{{R}_{1}}{{R}_{2}} \cdot \frac{{V}_{SET}}{{R}_{SET}} \cdot \frac{{R}_{CMP}}{{R}_{CMP} - ( 1 - α ) \cdot {R}_{1}}$$

If a ratio of the resistance R1 and the compensation resistance R_{CMP} is 1:2 (in other words, R₁=2*R_{CMP}), the compensation resistance R_{CMP} is eliminated from the expression above, and the expression can be rewritten as follows:

$${I}_{OUT} = \frac{{V}_{SET}}{{R}_{SET}} \cdot \frac{{R}_{1}}{{R}_{2}} \cdot \frac{{α}^{2}}{2 \cdot α - 1} = \frac{{V}_{SET}}{{R}_{SET}} \cdot \frac{{R}_{1}}{{R}_{2}} \cdot \frac{{β}^{2}}{{β}^{2} - 1}$$

The expression above represents the output current obtained when the compensation circuit is included. Compared with when the compensation circuit is not included, a denominator of a term of the amplification factor β is different. When the compensation circuit is not included, “213” in the denominator polynomial is a main error factor. Table 1 illustrates simulation results of current errors in the output drive current occurred due to the variations in the amplification factor β, when the compensation circuit is not included and when the compensation circuit is included. The table 1 also illustrates effects of the compensation circuit when the amplification factor β is reduced.

TABLE 1

| | Current error | Current error |
|---|---|---|
| Amplification | (without compensation | (with compensation |
| factor β | circuit) | circuit) |
| 60 | −3.252% | +0.028% |
| 120 | −1.646% | +0.007% |
| 240 | −0.828% | +0.002% |

The pre-equalizer 70-2 arranged at a preceding stage of the light driving circuit 21 will now be described. The simplest example of the pre-equalizer 70-2 is a high frequency emphasizing circuit for compensating a degradation of a high-frequency band. An example of a primary high-frequency-emphasizing-type transfer function T_{HE}(S) is illustrated below. K is a gain and ω₀ is natural angular frequency.

$${T}_{HE} ( S ) = \frac{{ω}_{0} + K \cdot S}{S + {ω}_{0}}$$

The high-frequency-emphasizing-type transfer function T_{HE}(S) above is one of bilinear functions, and is obtained by adding a low-pass filter (LPF) component and a high-pass filter (HPF) component scaled up by K times that use a corner frequency in common.

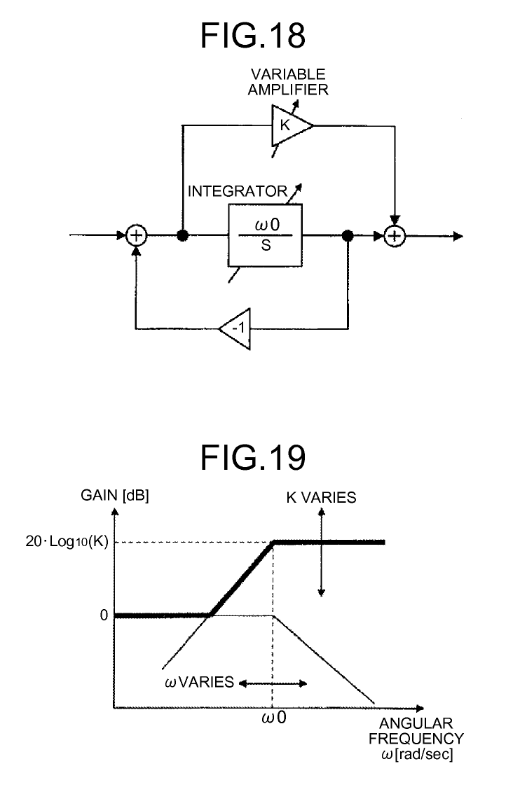

FIG. 18 is an exemplary block diagram of a transfer function of a primary high-frequency-emphasizing-type equalizer in the embodiment. In FIG. 18, K is a gain of a variable amplifier, and ω₀/S is an integral value of an integrator.

FIG. 19 is an exemplary graph illustrating an amplitude characteristic (piecewise linear approximation) of the primary high-frequency-emphasizing-type equalizer in FIG. 18. In FIG. 19, a vertical axis represents a gain [dB] of an equalizer, and a horizontal axis represents a frequency ω [rad/sec].

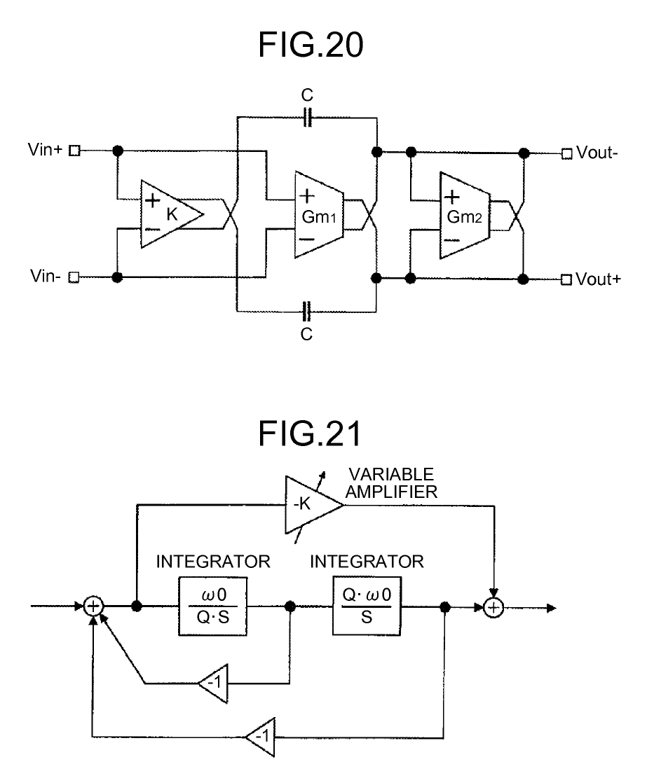

FIG. 20 is an exemplary symbolized circuit diagram of the block diagram in FIG. 18. The primary high-frequency-emphasizing-type equalizer illustrated in FIG. 20 is less likely to be affected by ground noise by using a floating capacity C (floating-C), and has a structure in which an entire circuit is simplified by connecting voltage signals in series and connecting currents in parallel by only using connection lines. In FIG. 20, Vᵢₙ+ and Vᵢₙ− denote respective input voltages, K denotes a gain, Gₘ₁ and Gₘ₂ denote respective values gm, Vₒᵤₜ− and Vₒᵤₜ+ denote respective output voltages, and C denotes a capacity.

Upon analyzing the primary high-frequency-emphasizing-type equalizer in FIG. 20, and focusing on current charged to the capacity C to express the transfer function T_{HE}(S) by a circuit parameter, the following relation is satisfied:

S·C·(Vₒᵤₜ−K·Vᵢₙ)=gₘ₁·Vᵢₙ−gₘ₂·Vₒᵤₜ

Accordingly, the transfer function T_{HE}(S) is given as follows:

$${T}_{HE} ( S ) = \frac{\frac{{g}_{m 1}}{C} + K \cdot S}{S + \frac{{g}_{m 2}}{C}} = \frac{{g}_{m 1}}{{g}_{m 2}} \cdot \frac{\frac{{g}_{m 2}}{C}}{S + \frac{{g}_{m 2}}{C}} + K \cdot \frac{S}{S + \frac{{g}_{m 2}}{C}}$$

A corner angular frequency ω₀ is given by gₘ₂/C, and gₘ₁/gₘ₂ gives a gain of the LPF component. Because gₘ₂ is related to a angular frequency, in this case, the frequency and the gain can be orthogonally adjusted, by just adjusting gₘ₁.

Similarly, a secondary high-frequency-emphasizing-type equalizer will be simply described. An example of a secondary transfer function is expressed as follows:

$${T}_{HE} ( S ) = \frac{{ω}_{0}^{2} - K \cdot {S}^{2}}{{S}^{2} + \frac{{ω}_{0}}{Q} \cdot S + {ω}_{0}^{2}}$$

The secondary transfer function such as above is also obtained by adding a secondary LPF component and HPF component multiplied by K times that use the corner angular frequency ω₀ and the selectivity (Q) in common. In other words, because a phase of the secondary HPF component is inverted relative to that of the LPF component by 180 degrees, the components are added by changing the sign to negative. If the sign of the gain K is positive, the secondary transfer function will be a band inhibiting type transfer function. Amplitude characteristics of the secondary transfer function are substantially the same as those of the primary transfer function, except that the equalization slope is an secondary slope. However, in the example of the secondary transfer function above, compared with the previous example of the primary transfer function, the numerator polynomial does not contain a complex term. Accordingly, regardless of the value of the gain K, a phase rotation does not occur. In other words, delay distortion due to equalization rarely occurs in the secondary high-frequency-emphasizing-type equalizer, and in order to be used as an equalizer, although the circuit scale is larger than that of the primary high-frequency-emphasizing-type equalizer, the secondary high-frequency-emphasizing-type equalizer is characteristically preferable.

FIG. 21 is an exemplary block diagram of a transfer function of the secondary high-frequency-emphasizing-type equalizer in the embodiment. In FIG. 21, −K denotes a gain of a variable amplifier, ω0/Q·S and Q·ω0/S denote respective integral values of two integrators.

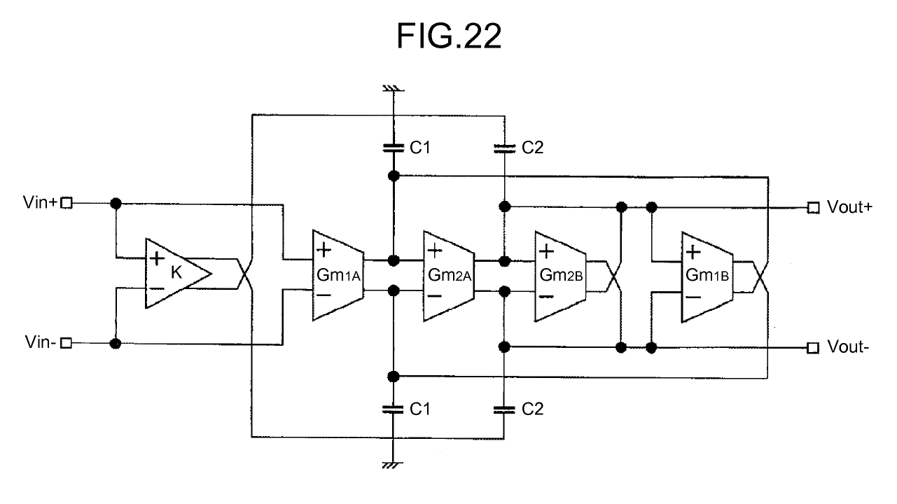

FIG. 22 is an exemplary symbolized circuit diagram of the block diagram in FIG. 21. The secondary high-frequency-emphasizing-type equalizer illustrated in FIG. 20 has a floating capacity (floating-C), is less likely to be affected by ground noise by using the floating capacity C (floating-C), and has a structure in which an entire circuit is simplified by connecting voltage signals in series and connecting currents in parallel by only using connection lines. In FIG. 22, Vᵢₙ+ and Vᵢₙ− denote respective input voltages, K denotes a gain, G_{m1A}, G_{m2A}, G_{m2B}, and G_{m1B} denote respective values gm, Vₒᵤₜ− and Vₒᵤₜ+ denote respective output voltages, and C1 and C2 denote respective capacities.

Upon analyzing the secondary high-frequency-emphasizing-type equalizer in FIG. 22, and by focusing on current charged to the capacity C to express the transfer function T_{HE}(S) with a circuit parameter, the following relation is satisfied:

$${T}_{HE} ( S ) = \frac{( \frac{{g}_{m 1 A}}{{g}_{m 1 B}} ) \cdot \frac{{g}_{m 1 B} \cdot {g}_{m 2 A}}{{C}_{1} \cdot {C}_{2}} - K \cdot {S}^{2}}{{S}^{2} + \frac{{g}_{m 2 B}}{{C}_{2}} \cdot S + \frac{{g}_{m 1 B} \cdot {g}_{m 2 A}}{{C}_{1} \cdot {C}_{2}}} ≡ \frac{{H}_{0} \cdot {ω}_{0}^{2} - K \cdot {S}^{2}}{{S}^{2} + \frac{{ω}_{0}}{Q} \cdot S + {ω}_{0}^{2}}$$

Main parameters are as follows: Hₒ is a direct current gain of the LPF component, coₒ is a natural angular frequency, and Q is the selectivity (sharpness of resonance).

$${H}_{0} = \frac{{g}_{m 1 A}}{{g}_{m 1 B}} , {ω}_{0} = \sqrt{\frac{{g}_{m 1 B} \cdot {g}_{m 2 A}}{{C}_{1} \cdot {C}_{2}}} , Q = \sqrt{\frac{{C}_{2}}{{C}_{1}} \cdot \frac{{g}_{m 1 B} \cdot {g}_{m 2 A}}{{g}_{m 2 B}^{2}}}$$

Because the capacities C₁ and C₂ are fixed, the frequency can be adjusted by simultaneously moving the conductances g_{m2A}, g_{m1B}, and g_{m2B}, regardless of the value of Q. Because the conductance g_{m1A} is related only to the DC gain H₀, the gain can be adjusted by just moving the conductance g_{m1A}, regardless of the other parameters. In this manner, all the parameters can be orthogonally adjusted.

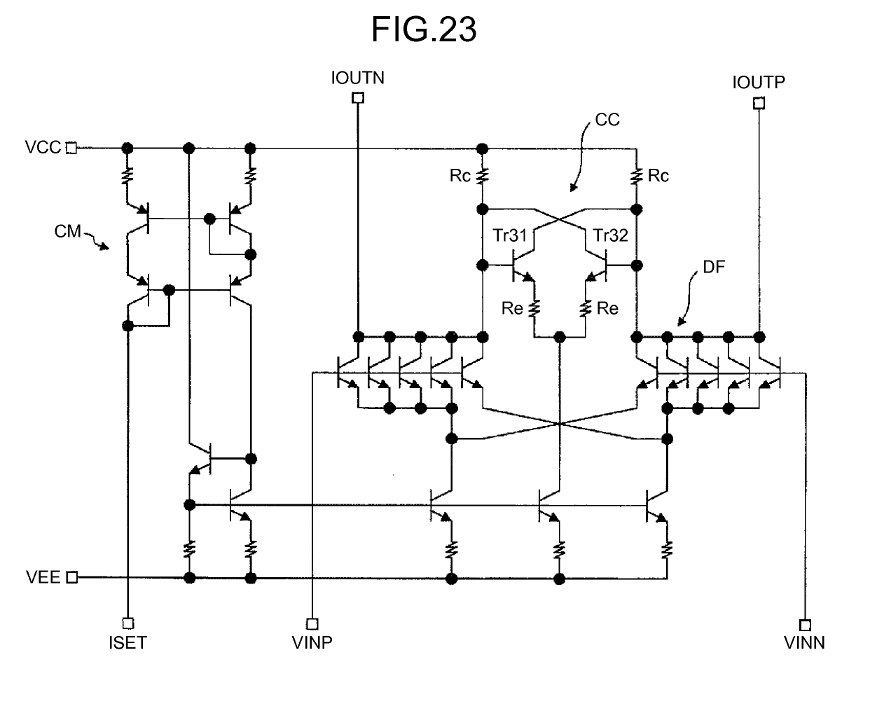

FIG. 23 is an exemplary circuit diagram of a gm amplifier, or a voltage-current conversion circuit, used for the pre-equalizer 70-2 in the embodiment. In the gm amplifier illustrated in FIG. 23, 21 pieces of bipolar transistors (and resistances) are connected. Basically, the gm amplifier in FIG. 23 has a basically similar structure to that of the gm amplifier in the light driving circuit 12 described in FIG. 17. In FIG. 23, Vcc denotes a power supply voltage, V_{EE} denotes a ground voltage, V_{INP} and V_{INN} denote respective input voltages, I_{OUTN} and I_{OUTP} denote respective output currents, and I_{SET} denotes a current from a constant current source (not shown).

The gm amplifier needs to have a high impedance load. In order to obtain high impedance, a method of using a current source and an operating point stabilizing circuit for performing common mode feedback is known. In the example, high impedance is achieved by conductance cancelling using a negative conductance.

As illustrated in FIG. 23, in a cross-connection stage CC composed of transistors Tr31 and Tr32 and resistances Re, diode connection in a positive feedback is used to obtain negative conductance. When an absolute value of a value gm of the cross-connection stage CC (Re negative conductance stage) is set to a value little smaller than an inverse of the load resistance Rc, a minute combined conductance, or a high resistance can be obtained by connecting a positive conductance and a negative conductance in parallel.

Each of elements in the circuit in FIG. 23 needs to have very high relative accuracy. In other words, it is not suitable for the elements that constantly need to maintain relationship between sizes of the positive and negative to have large relative fluctuations. This is because the circuit stability is in a trade-off relationship with desired high impedance.

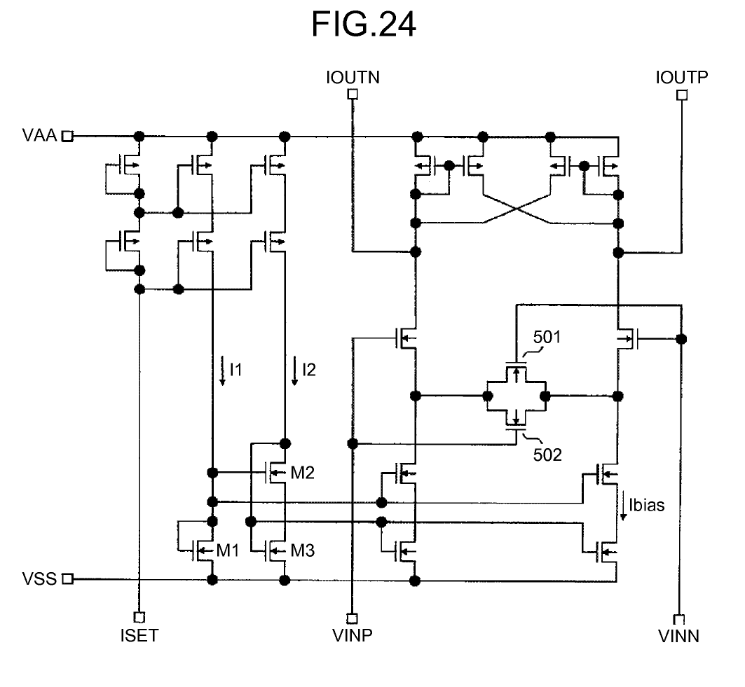

FIG. 24 is another exemplary circuit diagram of a gm amplifier, or a voltage-current converter circuit, used for the pre-equalizer 70-2 in the embodiment. In the gm amplifier illustrated in FIG. 24, 22 pieces of metal-oxide semiconductor (MOS) transistors are connected. MOS transistors are used as variable resistances, instead of using the unbalanced differential pair in FIG. 23. In FIG. 24, V_{AA} denotes a power supply voltage, V_{SS} denotes a ground voltage, V_{INP} and V_{INN} denote respective input voltages, I_{OUTN} and I_{OUTP} denote respective output currents, and I_{SET} denotes a current from a constant current source (not shown).

N-channel MOS (NMOS) transistors 501 and 502 are inserted between sources of a balanced differential pair. A circuit including the NMOS transistors 501 and 502 is used as a variable resistance in a triode region. A gate-source voltage of the differential pair is a gate-source voltage of a triode resistance, and values gm are all adjusted by bias current Ibias.

An NMOS current mirror circuit used in FIG. 24 will now be described.

In general, isolation characteristics between a drain and a source of a CMOS transistor are inferior to those of a bipolar transistor. Accordingly, in order to form a stable current source of an analog circuit with the CMOS transistors, it is preferable to facilitate a bias design, by arranging the CMOS transistors in a cascade structure to obtain high-impedance as illustrated in FIG. 24. If the cascade structure is not used, the CMOS transistor that forms each of the current sources cannot operate as a stable current source due to a drain modulation effect. Accordingly, it negatively affects operation of analog circuit. If the cascade structure is used, a required operational voltage range is sacrificed from the limited power supply voltage range. Accordingly, the drain potential should be reduced as much as possible.

The NMOS current mirror circuit in FIG. 24 includes a first current post composed of an NMOS transistor M1 and a second current post composed of NMOS transistors M2 and M3. The NMOS transistor M2 is a transistor for grounding a gate to connect in cascade, and the NMOS transistor M1 is provided to give a bias for grounding the gate.

Current transmission characteristics of the circuit in FIG. 24 and conditions required for the elements will now be described. For descriptive purposes, threshold voltages Vth of the CMOS transistors are assumed to be the same as each other. A drain-source voltage V_{DS3} of the NMOS transistor M3 of the second current post is expressed by the following expression. V_{GS1} and V_{Gs2} are respective gate-source voltages of the NMOS transistors M1 and M2, and V_{OVD1} and V_{OVD2} are respective overdrive voltages of the NMOS transistors M1 and M2.

V_{DS3}=V_{DS1}−V_{GS2}=(V_{OVD1}+Vth)−(V_{OVD2}+Vth)=V_{OVD1}−V_{OVD2}

In this manner, the drain-source voltage V_{DS3} of the NMOS transistor M3 is a difference between the overdrive voltages V_{OVD1} and V_{OVD2} of the NMOS transistors M1 and M2. In order to operate the NMOS transistor M3 in a saturation region, the drain-source voltage V_{DS3} of the NMOS transistor M3 needs to be larger than an overdrive voltage V_{OVD3} of the NMOS transistor M3. In other words, the following condition needs to be satisfied, to express a gate-source voltage V_{GS3} of the NMOS transistor M3:

V_{DS3}≧V_{OVD3}(=V_{GS3}−Vth)

Accordingly, the following expression can be obtained as the condition of the overdrive voltage of the NMOS transistor M3.

V_{OVD1}−V_{OVD2}≧V_{OVD3}

A drain current I_{D} in the saturation region of each of the NMOS transistors M1, M2, and M3 is proportional to an aspect ratio or to a square of the overdrive voltage, and is expressed by the following expression. L is a gate length, W is a gate width, and μN and Cox are respective constant numbers.

ID=(½)·μN·Cox·(W/L)·V_{OVD}²

Accordingly, the overdrive voltage V_{OVD} is as follows:

V_{OVD}=[{(2·I_{D})/(μN·Cox)}·(L/W)]^{1/2}

Consequently, the condition of the overdrive voltage of the NMOS transistor M3 can be rewritten as follows. L1, L2, and L3 are respective gate lengths of the NMOS transistors M1, M2 and M3. W1, W2, and W3 are respective gate widths of the NMOS transistors M1, M2, and M3. I1 and I2 are respective currents that flow to the NMOS transistors M1 and M2.

[{(2·I1)/(μN·Cox)}·(L1/W1)]^{1/2}[{(2·I2)/(μN·Cox)}·(L2/W2)]^{1/2}≧[{2·I2)/(μN·Cox)}·(L3/W3)]^{1/2}

If it is I1=I2 and M2=M3 in the expression above, the condition of the inverse of the aspect ratio can be obtained as follows:

(L1/W1)^{1/2}≧2·(L3/W3)^{1/2}→(L1/W1)≧4·(L3/W3)

Eventually, the relation of the aspect ratio needs to satisfy the following condition:

(W1/L1)_{M1}≦(¼)·(W3/L3)_{M3}

In order to keep the NMOS transistor M3 within the saturation range, the gate width of the NMOS transistor M1 needs to be set equal to or less than a quarter of that of the NMOS transistor M3, or the gate length of the NMOS transistor M1 needs to be set equal to or more than four times that of the NMOS transistor M3. In order to increase an active operational voltage of the circuit as much as possible, it is preferable to reduce the drain-source voltage V_{DS} of the NMOS transistor of the current mirror circuit as small as possible up to the saturation region. The drain-source voltage V_{DS2} of the NMOS transistor M2 at this time is V_{DS2}=Vth.

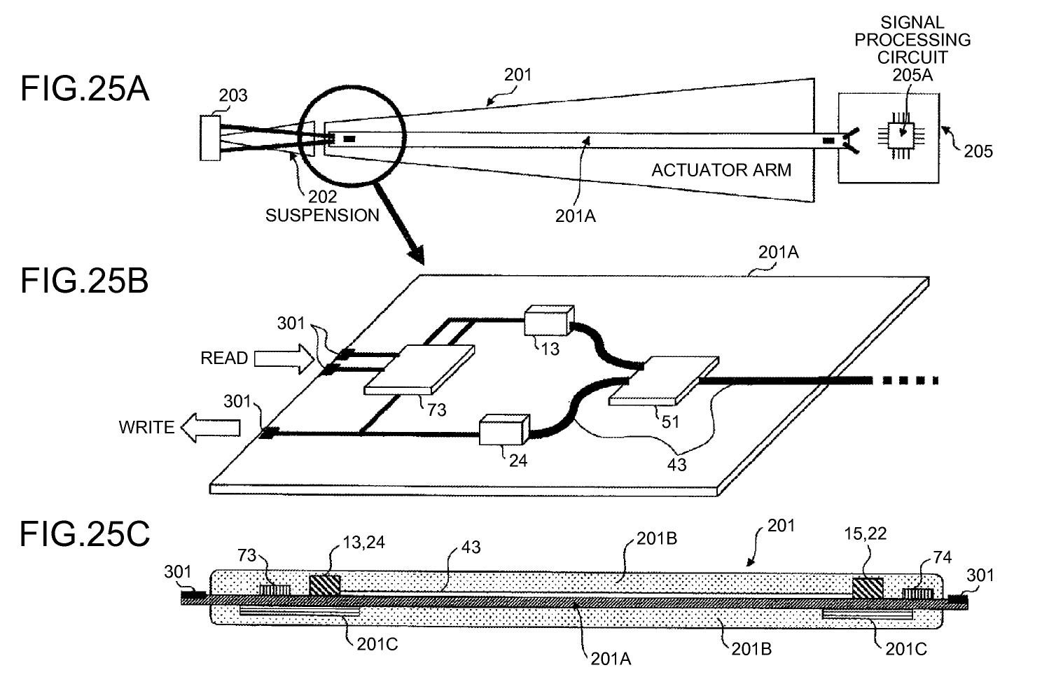

FIG. 25A is an exemplary plan view of an actuator arm of the magnetic disk device in the embodiment. FIG. 25B is an exemplary enlarged perspective view of a circled portion in FIG. 25A. FIG. 25C is an exemplary cross-sectional view of the actuator arm in the embodiment. For descriptive purposes, the sixth embodiment illustrated in FIG. 6 is applied to a signal transmission between a magnetic head and a signal processing circuit performed through the actuator arm. Needless to say, the other embodiments may similarly be applied.

As illustrated in FIG. 25A, an end of an actuator arm 201 is connected to a magnetic head module 203 through a suspension 202, and a rotatably supported base end of the actuator arm 201 is connected to a printed circuit board 205. The magnetic head module 203 includes the read head 11 that is a reading element and the write head 26 that is a recording element. A signal processing circuit 205A is mounted on the printed circuit board 205, and the RDC 30, the processor, and the like may also be included in the signal processing circuit 205A.

As illustrated in FIG. 25B, a flexible printed circuit board 201A is mounted on the actuator arm 201. Bonding pads 301 to connect a top portion of the actuator arm 201 with the magnetic head module 203, the controller 73, the electro optical converter circuit (laser diode) 13, the photo-electric converter circuit (photodiode) 24, the optical multiplexer-demultiplexer circuit 51, the optical transmission medium 43, and the like are mounted on the flexible printed circuit board 201A. Elements similar to those in FIG. 25B are provided on the flexible printed circuit board 201A, at the base portion of the actuator arm 201. However, the illustration and description thereof are omitted.

As illustrated in FIG. 25C, an upper surface of the flexible printed circuit board 201A is protected by a protective film 201B. A reinforcement board 201C to reinforce the top portion and the base portion of the actuator arm 201 is provided at the lower surface of the flexible printed circuit board 201A. The lower surface of the flexible printed circuit board 201A is also protected by the protective film 201B. The bonding pads 301 used to connect with the signal processing circuit 205A are provided on the flexible printed circuit board 201A, at the base portion of the actuator arm 201.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A signal transmitter comprising:
a first electro optical converter configured to convert a read electric signal to a first optical signal comprising a first wavelength (λR);
a first photo-electric converter configured to reconvert the first optical signal to the read electric signal;
a second electro optical converter configured to convert an electric signal to be recorded to a second optical signal comprising
a second wavelength (λW) different from the first wavelength (λR);
a second photo-electric converter configured to reconvert the second optical signal to the electric signal to be recorded;
a first optical multiplexer and demultiplexer connected to the first electro optical converter and the second photo-electric converter, and configured to multiplex the first optical signal and the second optical signal and to demultiplex the first optical signal and the second optical signal;
a second optical multiplexer and demultiplexer connected to the second electro optical converter and the first photo-electric converter, and configured to multiplex the first optical signal and the second optical signal and to demultiplex the first optical signal and the second optical signal; and
an optical transmission medium connected to the first optical multiplexer and demultiplexer and the second optical multiplexer and demultiplexer, and configured to transmit the multiplexed first and second optical signals.

2. The signal transmitter of claim 1, wherein the first and the second optical multiplexers and demultiplexers are optical diffraction filters.

3. The signal transmitter of claim 1, wherein first and the second optical multiplexers and demultiplexers are optical circulators.

4. The signal transmitter of claim 1, further comprising:
a first output level controller connected to the first electro optical converter, and configured to control an output level of the first optical signal;
a second output level controller connected to the second electro optical converter, and configured to control an output level of the second optical signal;
a first output level monitor connected to the first photo-electric converter, and configured to monitor an output level of the read electric signal reconverted by the first photo-electric converter; and
a second output level monitor connected to the second photo-electric converter, and configured to monitor an output level of the electric signal to be recorded reconverted by the second photo-electric converter,
wherein the first output level monitor is configured to transmit the output level of the read electric signal to the first output level controller through the optical transmission medium, by using the second electro optical converter, and
the second output level monitor is configured to transmit the output level of the electric signal to be recorded to the second output level controller through the optical transmission medium, by using the first electro optical converter, and
the first output level controller is configured to control the output level of the first optical signal based on the output level of the read electric signal, and
the second output level controller is configured to control the output level of the second optical signal based on the output level of the electric signal to be recorded.

5. The signal transmitter of claim 4, further comprising:
a first analog-to-digital converter connected to the first output level monitor, and configured to analog-to-digital convert the output level of the read electric signal;
a second analog-to-digital converter connected to the second output level monitor, and configured to analog-to-digital convert the output level of the electric signal to be recorded;
a first digital-to-analog converter connected to the first output level controller, and configured to digital-to-analog convert the output level of the analog-to-digital converted signal by the first analog-to-digital converter; and
a second digital-to-analog converter connected to the second output level controller, and configured to digital-to-analog convert the output level of the analog-to-digital converted signal by the second analog-to-digital converter.

6. The signal transmitter of claim 5, wherein the first output level monitor, the second output level controller, the first analog-to-digital converter, and the second digital-to-analog converter are in a first integrated circuit, and the second output level monitor, the first output level controller, the second analog-to-digital converter, and the first digital-to-analog converter are in a second integrated circuit.

7. The signal transmitter of claim 6, wherein the first integrated circuit further comprises a first switching circuit configured to supply an output signal of the first digital-to-analog converter to the first output level controller when the read electric signal is read, and to supply an output signal of the first output level monitor to the first output level controller when the electric signal to be recorded is output, and
wherein the second integrated circuit further comprises a second switching circuit configured to supply an output signal of the second digital-to-analog converter to the second output level controller when the electric signal to be recorded is output, and to supply an output signal of the second output level monitor to the second output level controller when the read electric signal is read.

8. The signal transmitter of claim 1, further comprising:
a first linear modulation type light driving circuit configured to linearize the read electric signal and to supply the linearized read electric signal to the first electro optical converter; and
a second linear modulation type light driving circuit configured to linearize the electric signal to be recorded and to supply the linearized read electric signal to be recorded to the second electro optical converter.

9. A storage device comprising:
a head comprising a reading element and a recording element; and
a signal transmitter connected to the head,
wherein the signal transmitter comprises:
a first electro optical converter configured to convert a read electric signal from the reading element to a first optical signal comprising a first wavelength (λR);
a first photo-electric converter configured to reconvert the first optical signal to the read electric signal;
a second electro optical converter configured to convert a electric signal to be recorded from the recording element to a second optical signal comprising a second wavelength (λW) different from the wavelength (λR);
a second photo-electric converter configured to reconvert the second optical signal to the electric signal to be recorded;
a first optical multiplexer and demultiplexer connected to the first electro optical converter and the second photo-electric converter, and configured to multiplex the first optical signal and the second optical signal and to demultiplex the first optical signal and the second optical signal;
a second optical multiplexer and demultiplexer connected to the second electro optical converter and the first photo-electric converter, and configured to multiplex the first optical signal and the second optical signal and to demultiplex the first optical signal and the second optical signal; and
an optical transmission medium connected to the first optical multiplexer and demultiplexer and the second optical multiplexer and demultiplexer, and configured to transmit the multiplexed first and second optical signals.

10. The storage device of claim 9, further comprising:
an actuator arm, the head being on an end of the actuator arm,
wherein the signal transmitter is on the actuator arm.
